(19) United States
(12) Patent Application Publication
(10) Pub. No.: US 2020/0036760 A1
(43) Pub. Date: Jan. 30, 2020

(54) STANDARDIZED HOT-PLUGGABLE TRANSCEIVING UNIT AND METHOD FOR TRANSMITTING A MULTICAST COMMAND FOR SYNCHRONIZED MEDIA SWITCH

(71) Applicant: EMBRIONIX DESIGN INC., Laval (CA)

(72) Inventors: Renaud Lavoie, Laval (CA); Sebastien Berthiaume, ST-EUSTACHE (CA); Sithideth Viengkhou, Montreal (CA)

(73) Assignee: EMBRIONIX DESIGN INC., Laval (CA)

(21) Appl. No.: 16/045,223

(22) Filed: Jul. 25, 2018

(51) Int. Cl. H04L 29/06; H04N 21/6405; H04N 21/643

(52) U.S. Cl. CPC H04L 65/1066; H04L 65/602; H04L 65/1003; H04N 21/64322; H04L 65/608; H04N 21/6405

(57) ABSTRACT

Computing device and method for transmitting a multicast command for synchronized media switch. The computing device generates a multicast IP packet comprising a command for switching from a first media stream to a second media stream. The command comprises synchronization information defining when to perform the switch. The computing device transmits the multicast IP packet comprising the switch command to a remote computing device receiving the first and second media streams. The synchronization information consists of a time or a given video frame at which the switch shall be performed. According to a particular aspect, the computing device is a transceiving unit (e.g. an SFP unit) comprising a housing adapted to being inserted into a chassis of a hosting unit. According to another particular aspect, the multicast IP packet is compliant with the SAP protocol and the command is compliant with the SDP format.

### TECHNICAL FIELD

The present disclosure relates to the field of standardized hot-pluggable transceiving units. More specifically, the present disclosure relates to a standardized hot-pluggable transceiving unit and method for transmitting a multicast command for synchronized media switch.

### BACKGROUND

Small Form-factor Pluggable (SFP) units represent one example of standardized hot-pluggable transceiving units. SFP units are standardized units adapted to be inserted within a chassis of a hosting unit. A suite of specifications, produced by the SFF (Small Form Factor) Committee, describe the size of the SFP unit, so as to ensure that all SFP compliant units may be inserted smoothly within one same chassis, i.e. inside cages, ganged cages, superposed cages and belly-to-belly cages. Specifications for SFP units are available at the SFF Committee website.

SFP units may be used with various types of exterior connectors, such as coaxial connectors, optical connectors, RJ45 connectors and various other types of electrical connectors. In general, an SFP unit allows connection between an external apparatus, via a front connector of one of the aforementioned types, and internal components of a hosting unit, for example a motherboard, a card or a backplane leading to further components, via a back interface of the SFP unit. Specification no INF-8074i Rev 1.0, entitled “SFP (Small Form-factor Pluggable) Transceiver, dated May 12, 2001, generally describes sizes, mechanical interfaces, electrical interfaces and identification of SFP units.

The SFF Committee also produced specification no SFF-8431 Rev. 4.1, “Enhanced Small Form-factor Pluggable Module SFP+”, dated Jul. 6, 2010. This document, which reflects an evolution of the INF-8074i specification, defines, inter alia, high speed electrical interface specifications for 10 Gigabit per second SFP+ modules and hosts, and testing procedures. The term “SFP+” designates an evolution of SFP specifications.

INF-8074i and SFF-8431 do not generally address internal features and functions of SFP devices. In terms of internal features, they simply define identification information to describe SFP devices' capabilities, supported interfaces, manufacturer, and the like. As a result, conventional SFP devices merely provide connection means between external apparatuses and components of a hosting unit, the hosting unit in turn exchanging signals with external apparatuses via SFP devices.

Recently, SFP units with internal features and functions providing signal processing capabilities have appeared. For instance, some SFP units now include signal re-clocking, signal reshaping or reconditioning, signals combination or separation, signal monitoring, etc.

In the field of video transport, advances have been made recently for transporting the payload of a video signal into Internet Protocol (IP) packets. Legacy protocols such as the Session Description Protocol (SDP) and the Session Announcement Protocol (SAP) can be used in this context for exchanging data defining the properties of a video stream (or audio stream) between a video source and a video receiver. The data defining the properties of the video stream are used by the video receiver to configure its software and/or hardware to support the reception of the video stream, and to initiate the reception of the video stream (e.g. join a multicast IP address associated to the video stream).

In the field of professional video transmission (e.g. television broadcasters), the aforementioned exchange of information between sources and receivers is generally controlled by a centralized control system, which can be implemented by an SFP unit.

However, legacy protocols such as the SDP and the SAP protocols do not support the initiation (via the transmission of a command) of a synchronized switch (a switch occurring upon a given condition) from a first video stream to a second video stream at a video receiver.

Therefore, there is a need for a standardized hot-pluggable transceiving unit and method for transmitting a multicast command for synchronized media switch.

### SUMMARY

According to a first aspect, the present disclosure provides a computing device. The computing device comprises a communication interface and a processing unit. The processing unit generates a multicast Internet Protocol (IP) packet comprising a command for switching from a first media stream to a second media stream. The command comprises synchronization information defining when to perform the switch. The processing unit transmits the multicast IP packet comprising the switch command via the communication interface to a remote computing device receiving the first and second media streams.

According to a second aspect, the present disclosure provides a method for transmitting a multicast command for synchronized media switch. The method comprises generating, by a processing unit of a computing device, a multicast Internet Protocol (IP) packet comprising a command for switching from a first media stream to a second media stream. The command comprises synchronization information defining when to perform the switch. The method comprises transmitting, by the processing unit of the computing device, the multicast IP packet comprising the switch command (via a communication interface of the computing device) to a remote computing device receiving the first and second media streams.

According to a third aspect, the present disclosure provides a non-transitory computer program product comprising instructions executable by a processing unit of a computing device. The execution of the instructions by the processing unit of the computing device provides for transmitting a multicast command for synchronized media switch, according to the aforementioned method.

According to a particular aspect, the computing device is a transceiving unit comprising a housing adapted to being inserted into a chassis of a hosting unit, the processing unit is in the housing, and the communication interface is a connector of the transceiving unit.

According to another particular aspect, the transceiving unit is a standardized hot-pluggable transceiving unit comprising a housing having standardized dimensions (e.g. an SFP unit).

According to still another particular aspect, the multicast IP packet is compliant with the SAP protocol and the command is compliant with the SDP format.

### BRIEF DESCRIPTION OF THE DRAWINGS

Embodiments of the disclosure will be described by way of example only with reference to the accompanying drawings, in which:

FIG. 1 is a top view of an SFP unit;

FIG. 2 is a side elevation view of the SFP unit of FIG. 1;

FIG. 3 is a front elevation view of the SFP unit of FIG. 1;

FIG. 4 is back elevation view of the SFP unit of FIG. 1;

FIG. 5 is a bottom view of the SFP unit of FIG. 1;

FIG. 6 is a perspective view of the SFP unit of FIG. 1;

FIGS. 7A, 7B and 7C illustrate the initiation of a transmission of two media streams using SDP profiles for characterizing the two media streams;

FIGS. 8A, 8B and 8C illustrate the initiation of a transmission of an additional media stream using an SDP profile for characterizing the additional media stream;

FIGS. 9A and 9B illustrate the transmission of a multicast switch command for switching from one of the initial media streams of FIGS. 7A-7C to the additional media stream of FIGS. 8A-8C;

FIGS. 10A, 10B and 10C illustrate another configuration for the transmission of the multicast switch command of FIGS. 9A-9B;

FIG. 11 represents a computing device adapted for implementing the controller of FIGS. 7A to 10C;

FIGS. 12A and 12B represent an SFP unit adapted for being inserted into a port of the controller of FIGS. 7A to 10C;

FIG. 13 represents a computing device adapted for implementing the video source of FIGS. 7A to 10C; and

FIGS. 14A and 14B represent a method for transmitting a multicast command for synchronized media switch.

### DETAILED DESCRIPTION

The foregoing and other features will become more apparent upon reading of the following non-restrictive description of illustrative embodiments thereof, given by way of example only with reference to the accompanying drawings.

The present disclosure describes standardized hot-pluggable transceiving units, such as Small Form-factor Pluggable (SFP)/SFP+ units, having internal features that far exceed those of conventional units. Conventional units merely provide connection capabilities between a hosting unit in which they are inserted and external apparatuses. The standardized hot-pluggable transceiving unit disclosed herein provides the capability of managing the transmission of media streams (e.g. video and/or audio streams) from sources to receivers. In particular, the standardized hot-pluggable transceiving unit disclosed herein provides the capability of transmitting a multicast command for performing a synchronized switch from a first media to a second media at a receiver receiving the first and second media.

The following terminology is used throughout the present disclosure:
SFP: Small Form-factor Pluggable, this term refers to units that are insertable into a chassis of a hosting unit; in the present disclosure, an SFP unit complies with an industry standard specification.
Connector: A device component for physically joining circuits carrying electrical, optical, radio-frequency, or like signals.
   Standardized Hot-Pluggable Transceiving Unit with Conventional Capabilities

In the rest of the disclosure, an SFP unit is used to illustrate an example of a standardized hot-pluggable transceiving unit. However, the teachings of the present disclosure are not limited to an SFP unit; but can be applied to any type of standardized hot-pluggable transceiving unit.

An SFP unit comprises a housing having a front panel, a back panel, a top, a bottom and two sides. Generally, the front panel includes at least one connector for connecting a cable, a fiber, twisted pairs, etc. The back panel includes at least one rear connector for connecting to a hosting unit. However, some SFP units may have no front connector, or alternatively no rear connector. The SFP unit may be fully-compliant or partially compliant with standardized SFP dimensions, such as SFP, SFP+, XFP (SFP with 10 Gigabit/s data rate), Xenpak, QSFP (Quad (4-channel) SFP with 4×10 Gigabit/s data rate), QSFP+, CFP (C form-factor pluggable with 100 Gigabit/s data rate), CPAK or any other standardized Small Form-factor Pluggable unit.

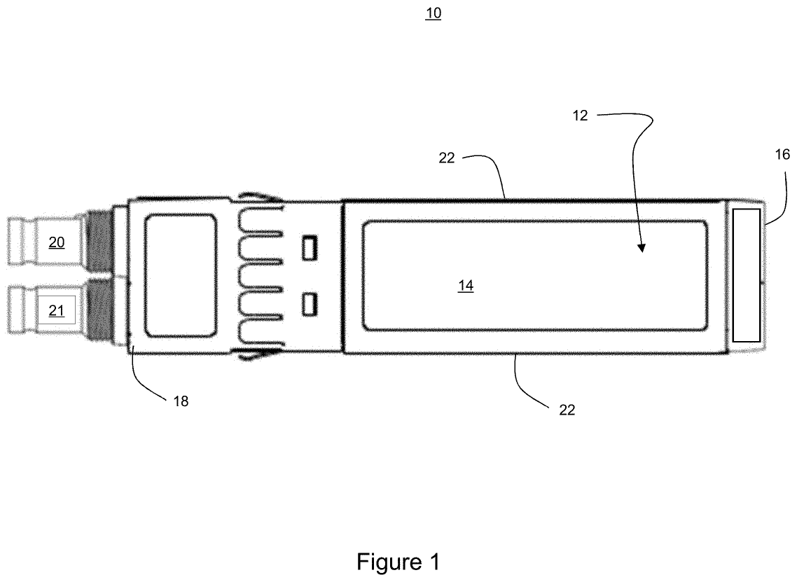

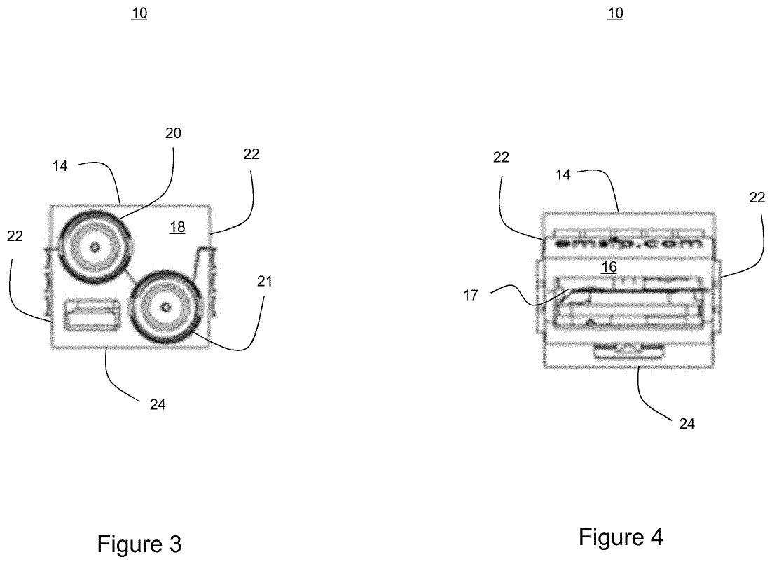

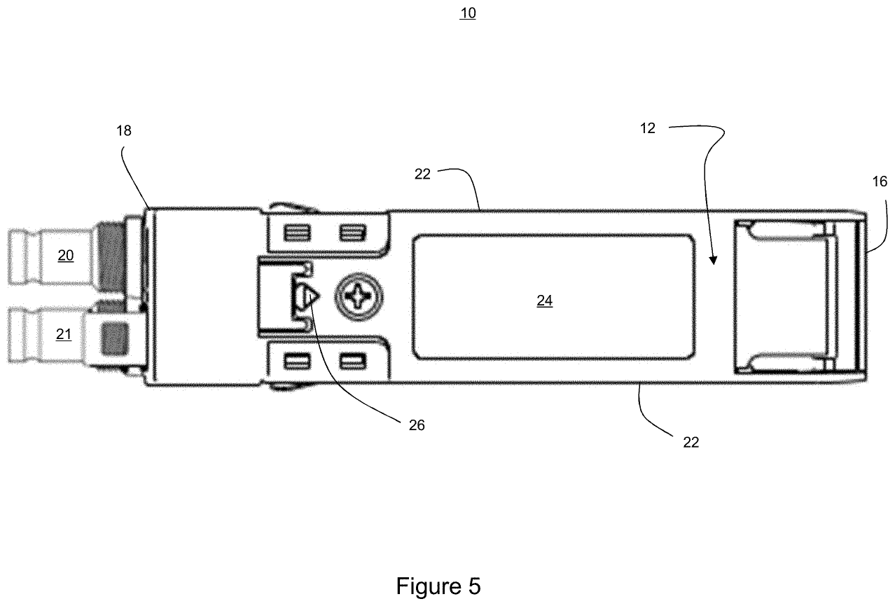

Reference is now made concurrently to FIGS. 1-6, which are, respectively, a top view, a side elevation view, a front elevation view, a back elevation view, a bottom view and a perspective view of an SFP unit 10. The SFP unit 10 comprises a housing 12. The housing defines a top 14, a bottom 24, and two sides 22. The housing 12 is at least partially of dimensions in compliance with at least one of the following standards: SFP, SFP+, XFP, Xenpak, QSFP, QSFP+, CFP, CPAK, etc. Alternatively, the housing 12 has functional dimensions based on at least one of the following standards: SFP, SFP+, XFP, Xenpak, QSFP, QSFP+, CFP, CPAK, etc.

The SFP unit 10 further comprises a back panel 16 affixed to the housing 12. The back panel 16 comprises a rear connector 17, for instance an electrical or an optical connector. In an example, the back panel 16 comprises the rear connector 17 (also named a host connector) suitable to connect the SFP unit 10 to a backplane of a chassis (not shown for clarity purposes) of a hosting unit, as known to those skilled in the art. More specifically, the connection is performed via a port of the hosting unit adapted for insertion of the SFP unit 10 and connection of the rear connector 17 to the backplane of the hosting unit.

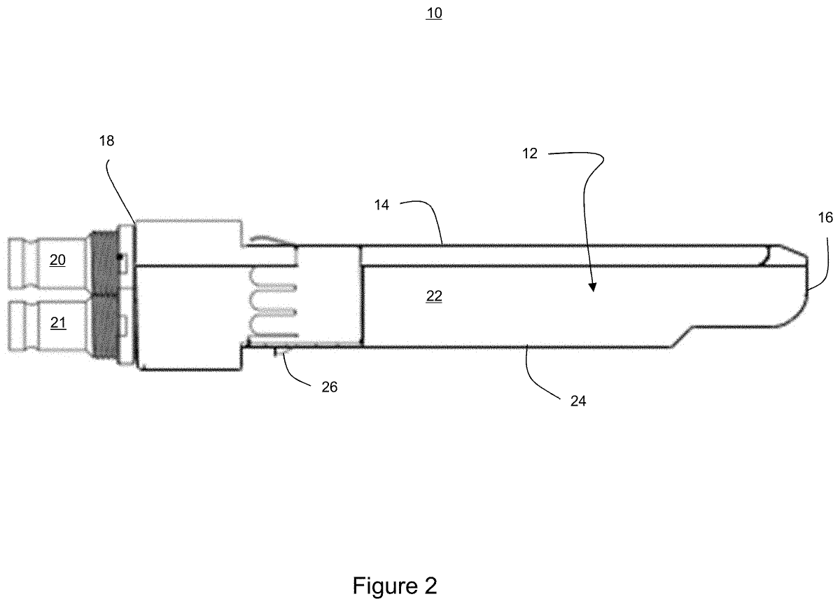

The SFP unit 10 further comprises a front panel 18 affixed to the housing 12. The front panel 18 comprises one or more connectors, for example a connector 20 of a co-axial cable type, adapted to send and/or receive video IP flows and a connector 21, also of the co-axial cable type, also adapted to send and/or receive video IP flows. The SFP unit 10 further comprises an engagement mechanism, such as for example a latch 26 as shown in a resting position on the bottom 24 in FIG. 2, for maintaining the SFP unit 10 in place within a chassis.

### Multicast Command for Synchronized Media Switch

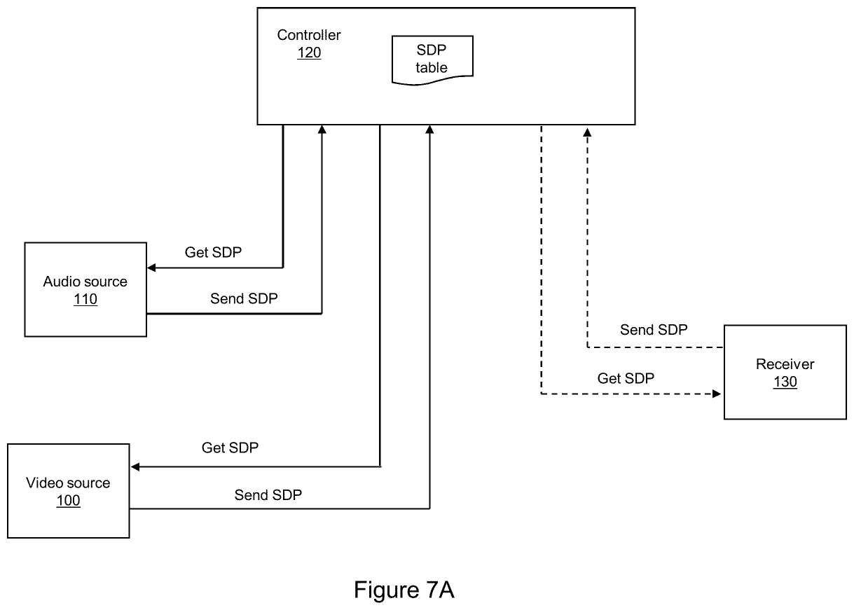

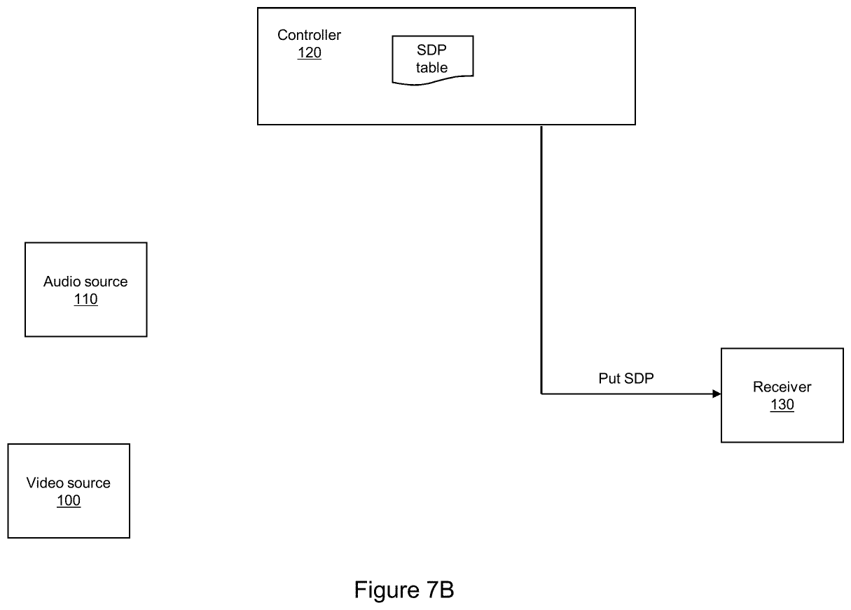

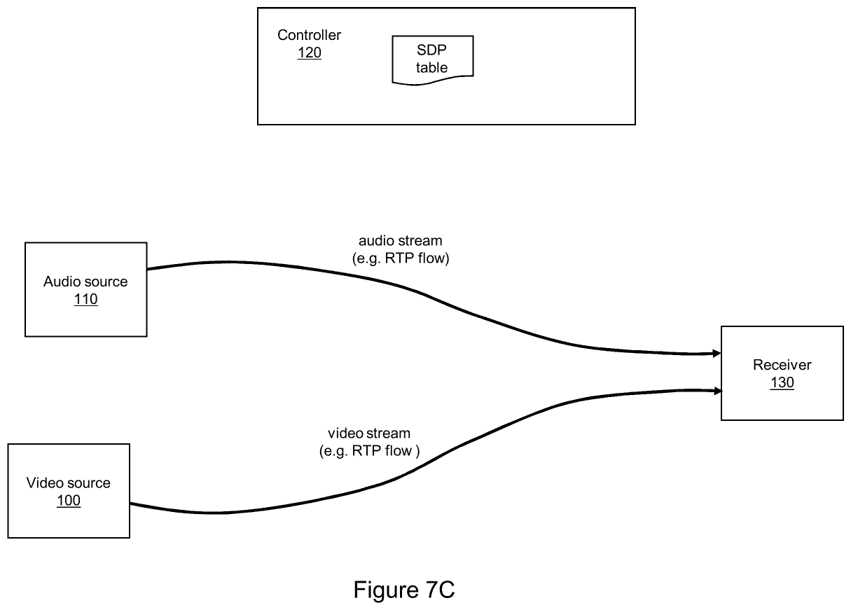

Reference is now made to FIGS. 7A, 7B and 7C, which illustrate the initiation of a video transmission over an IP networking infrastructure.

The IP networking infrastructure is not represented in the Figures for simplification purposes. However, any transmission of data illustrated in the Figures is based on the Internet Protocol.

The present disclosure is directed to the transmission of video, which is usually not limited to video, but also includes the transmission of at least one of audio (e.g. soundtracks) and metadata (e.g. close captions). However, the teachings of the present disclosure can be extended to the transmission of any other media (e.g. audio only, etc.).

The initiation of a video transmission includes an initial phase where characteristics of the transmitted media (e.g. video, audio, etc.) are exchanged between source(s) and receiver(s). In the present context, the video transmission is usually unidirectional. Therefore, the initial phase mainly consists in transmitting the media characteristics from the source(s) to the receiver(s).

The Session Description Protocol (SDP) is used during the initial phase for transmitting the characteristics of the media. SDP is a well known protocol, which has been used extensively, for example in the context of Voice over IP (VoIP).

SDP payloads can be transported via various IP based protocols, such as the Session Initiation Protocol (SIP), the Session Announcement Protocol (SAP), the Real Time Streaming Protocol (RTSP), the Hypertext Transfer Protocol (HTTP), etc.

SDP can be used in the context of a centralized architecture or a decentralized architecture. For example, in the case of VoIP, peers advertise their respective capabilities through the SDP protocol in a decentralized manner. However, in the present context of video transmission, a centralized architecture is used.

FIGS. 7A, 7B and 7C illustrate the initiation of a video transmission from a video source 100 and an audio source 110 to a receiver 130, under the control of a controller 120. The controller 120 is in charge of managing a plurality of video transmissions, from a plurality of sources to a plurality of receivers. Only one video transmission is represented in the Figures for simplification purposes.

The controller 120 sends a request (get SDP in FIG. 7A) respectively to the video source 100 and the audio source 110, for retrieving the characteristics of the video stream and the audio stream respectively generated by the video source 100 and the audio source 110. The video source 100 and the audio source 110 transmit the respective characteristics of the video stream and the audio stream to the controller 120 via SDP payloads (send SDP in FIG. 7A).

For example, a Representational State Transfer (REST) Application Programming Interface (API) based on the HTTP protocol is used between the controller 120 and the media sources (100 and 110) to request/transmit the SDP payloads defining the media characteristics.

For each media stream, the controller 120 stores an SDP profile in an SDP table. The SDP table is a data structure stored in a memory of the controller 120. For instance, the SDP table comprises one SDP profile for the video stream generated by the video source 100 and one SDP profile for the audio stream generated by the audio source 110. The SDP profile for the video stream generated by the video source 100 is a copy of the SDP payload transmitted (send SDP in FIG. 7A) from the video source 100 to the controller 120. Alternatively, the SDP payload received from the video source 100 is adapted by the controller 120 to generate the SDP profile stored in the SDP table. The same applies to the SDP profile for the audio stream generated by the audio source 110.

A single equipment may simultaneously generate several streams, in which case a plurality of SDP profiles respectively associated to each one of the streams is stored in the SDP table. For example, the video source 100 generates several video streams based on the same original video, using several scaling factors. A unique SDP profile is associated to each one of the scaled video streams.

Optionally, the controller 120 also retrieves an SDP profile from the receiver 130 (get SDP and send SDP in FIG. 7A). The SDP profile comprises characteristics of the receiver 130, these characteristics determining which types of video streams and audio streams the receiver 130 is capable of handling.

The controller 120 then transmits the SDP profiles of the video source 100 and the audio source 110 to the receiver 130 (put SDP in FIG. 7B).

The SDP profiles of the video source 100 and the audio source 110 are used by the receiver 130 for preparing the reception of the video stream and the audio stream. For example, the receiver 130 adapts its video processing and audio processing capabilities to the characteristics of the video stream and the audio stream as defined respectively by the video and audio SDP profiles.

Furthermore, the SDP profile for the video comprises a multicast address (corresponding to a multicast group) through which the video stream is transmitted. The receiver 130 joins the multicast group for receiving the video stream, as is well in the art of multicast. The video source 100 transmits the video stream via the multicast address.

Similarly, the SDP profile for the audio comprises another multicast address (corresponding to another multicast group) through which the audio stream is transmitted. The receiver 130 joins the other multicast group for receiving the audio stream. The audio source 110 transmits the audio stream via the other multicast address.

Alternatively, the video and audio streams are transmitted via unicast streams. In this case, the SDP profile for the video comprises the IP address of the video source 100. The receiver 130 transmits its own IP address to the video source 100, for example through its own SDP profile comprising its own IP address, its own SDP profile being transmitted to the video source 100. Similarly, the SDP profile for the audio comprises the IP address of the audio source 100. The receiver 130 transmits its own IP address to the audio source 110, for example through its own SDP profile comprising its own IP address, its own SDP profile being transmitted to the audio source 110. This use case is not represented in the Figures, which focus on the multicast use case.

At the end of the configuration procedure based on the transmission of SDP profiles (illustrated in FIGS. 7A and 7B), the transmission of the media starts, as illustrated in FIG. 7C.

An IP flow transporting the video payloads (video stream in FIG. 7C) is transmitted by the video source 100 to the receiver 130 and an IP flow transporting the audio payloads (audio stream in FIG. 7C) is transmitted by the audio source 110 to the receiver 130. As mentioned previously, the video IP flow and the audio IP flow are generally multicast; but may also be unicast.

An IP flow is well known in the art. It consists of a sequence of IP packets from a source (e.g. the video source 100) to a destination (e.g. the receiver 130). Several protocol layers are involved in the transport of the IP packets of the IP flow, including a physical layer (e.g. optical or electrical), a link layer (e.g. Media Access Control (MAC) for Ethernet), an Internet layer (e.g. IPv4 or IPv6), a transport layer (e.g. User Datagram Protocol (UDP)), and one or more application layers ultimately embedding an application payload (e.g. a video payload or an audio payload). The IP flow provides end-to-end delivery of the application payload over an IP networking infrastructure.

In the context of video and audio transmissions over IP, the UDP protocol is used for the transport layer. Furthermore, the video and audio payloads are usually embedded in the Real-Time Transport Protocol (RTP), which is considered a layer 5 (session) and 6 (presentation) in the Open Systems Interconnection (OSI) model.

Although the video source 100 and the audio source 110 have been represented as independent equipment in the Figures, a single equipment may implement simultaneously the video source 100 and the audio source 110. Furthermore, In an alternative configuration (not represented in the Figures for simplification purposes), a single source generates a single IP flow for simultaneously transporting the video and audio payloads. There is therefore a single media stream embedding video and audio payloads.

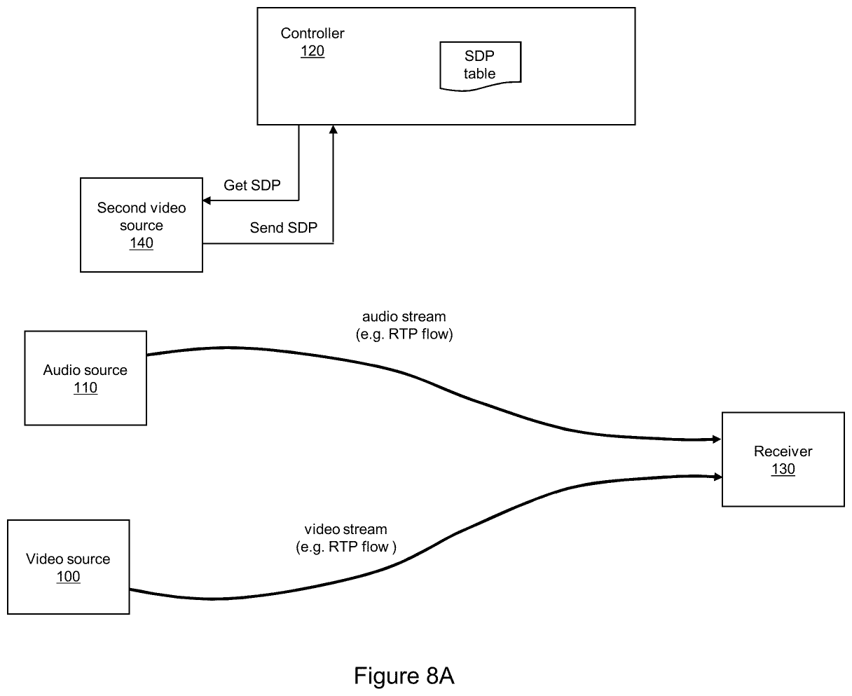

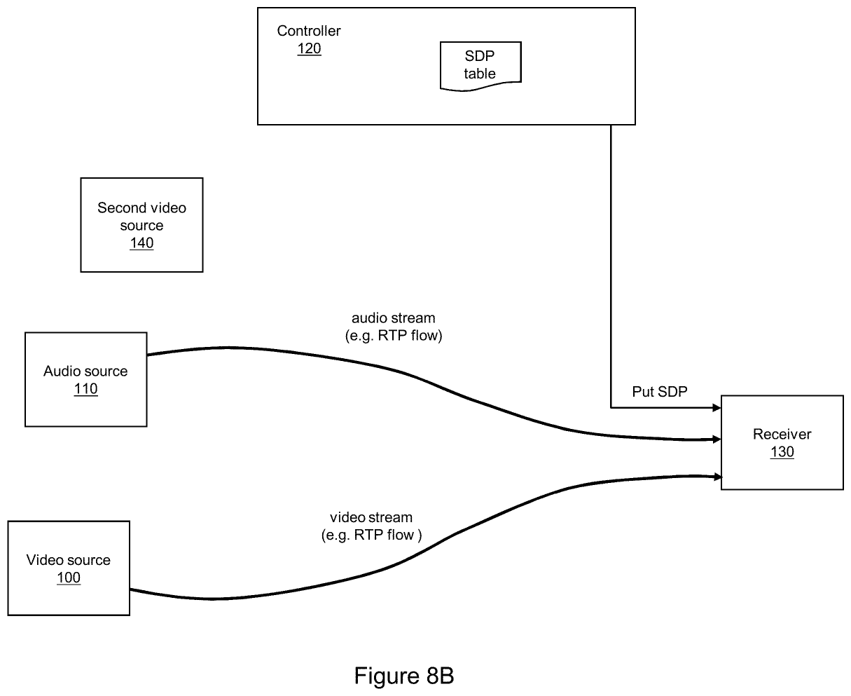

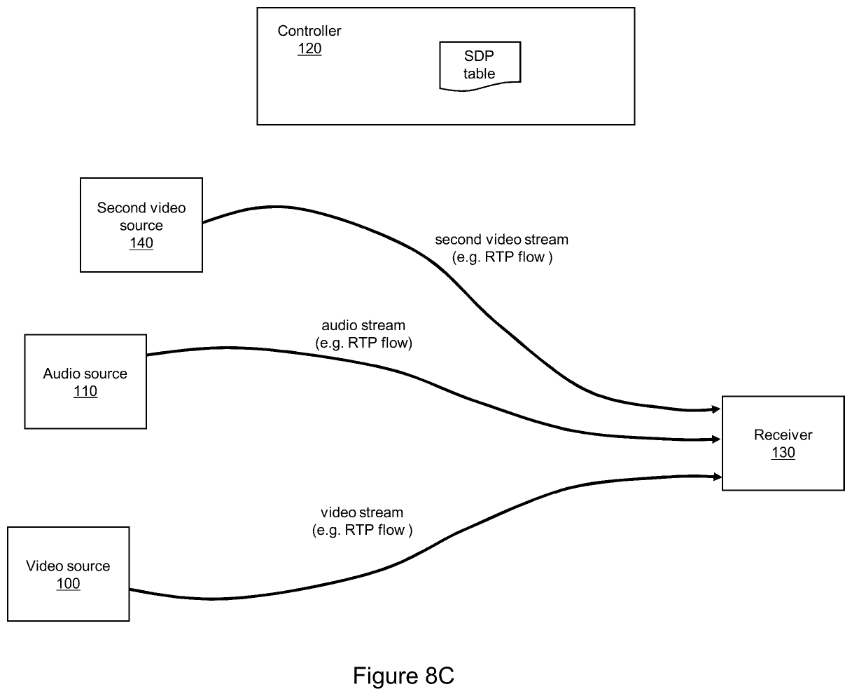

Reference is now made to FIGS. 8A, 8B and 8C, which illustrate the initiation of a second video stream generated by a second video source 140.

The video stream and the audio stream respectively transmitted by the video source 100 and the audio source 110 to the receiver 130 in FIGS. 8A, 8B and 8C correspond to the video and audio streams of FIG. 7C.

FIG. 8A illustrates the retrieval by the controller 120 of the SDP profile for the second video stream generated by the second video source 140. This retrieval is similar to the previously described retrieval by the controller 120 of the SDP profile for the video stream generated by the video source 100 illustrated in FIG. 7A.

The video stream generated by the video source 100 will also be referred to as the first video stream in the rest of the description.

FIG. 8B illustrates the transmission by the controller 120 of the SDP profile of the second video source 140 to the receiver 130. This transmission is similar to the previously described transmission by the controller 120 of the SDP profile of the video source 100 to the receiver 130 illustrated in FIG. 7B.

At the end of the configuration procedure based on the transmission of the SDP profile of the second video source 140 (illustrated in FIGS. 8A and 8B), the transmission of the second video stream from the second video source 140 to the receiver 130 starts, as illustrated in FIG. 8C. The characteristics and details of the transmission of the second video stream generated by the second video source 140 are similar to the previously described characteristics and details of the transmission of the video stream generated by the video source 100.

The simultaneous reception of the first video stream (from video source 100) and the second video stream (from video source 140) by the receiver 130 is representative of a make-before-break approach.

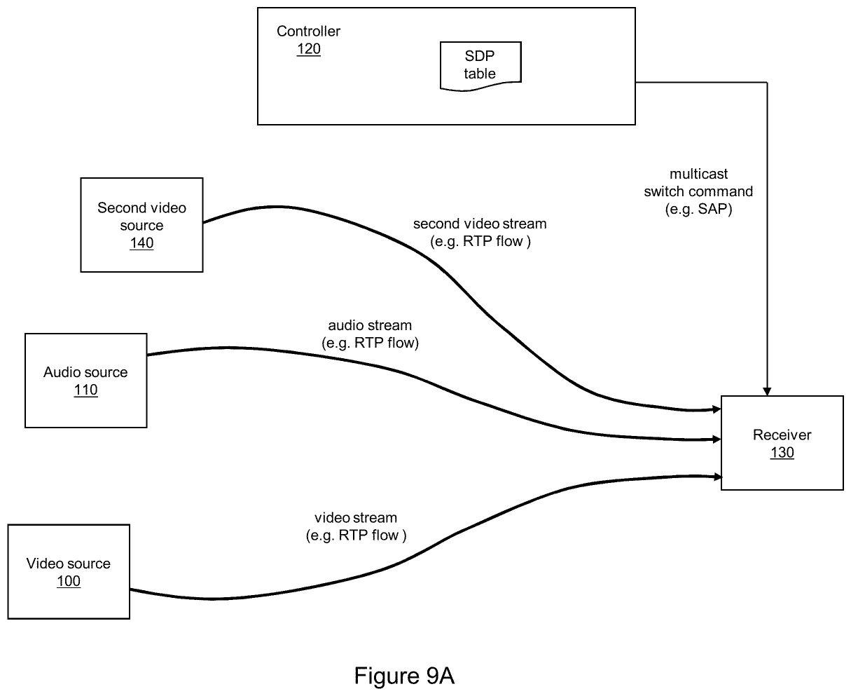

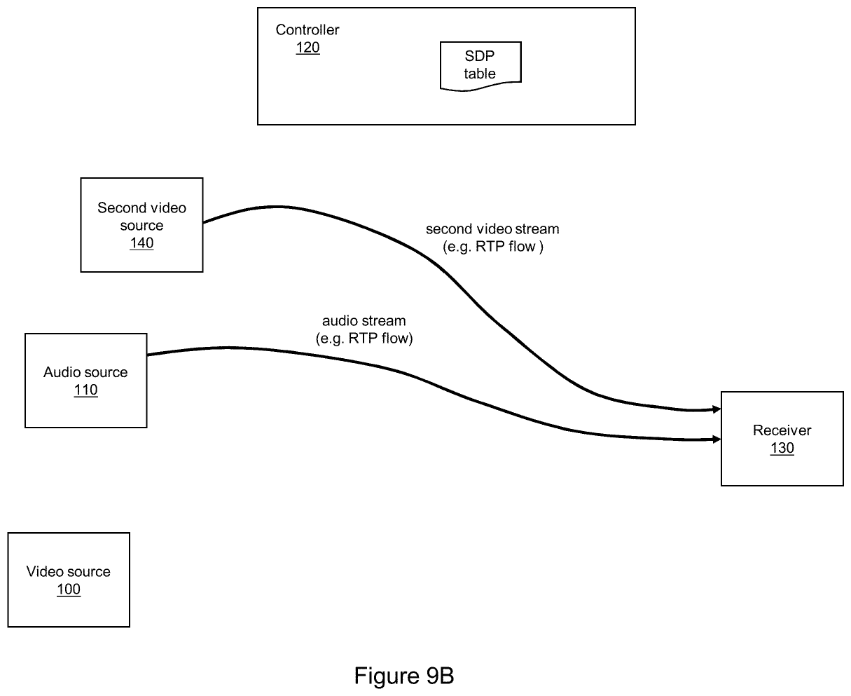

Initially, the receiver 130 only receives and uses the first video stream (FIGS. 7C, 8A and 8B). Then, the receiver 130 simultaneously receives the first and second video streams; but only uses the first video stream (FIGS. 8C and 9A). Finally, the receiver 130 only receives and uses the second video stream (FIG. 9B). This procedure provides a smooth transition from the first video stream to the second video stream. The aim of the present disclosure is to provide means for efficiently and precisely controlling the moment at which the receiver 130 switches from the first video stream to the second video stream.

Reference is now made to FIGS. 9A and 9B, which illustrate the control of the transition from the first video stream to the second video stream by the controller 120.

FIG. 9A illustrates the transmission by the controller 120 of a multicast switch command to the receiver 130. The switch command is transmitted via a multicast IP packet.

All the switch commands generated and transmitted by the controller 120 are transmitted via a pre-defined multicast IP address. Thus, each receiver 130 joins the multicast group corresponding to the pre-defined multicast IP address for receiving the switch commands. Alternatively, a plurality of pre-defined multicast IP addresses are used. A given one among the plurality of pre-defined multicast IP addresses is used for a given group of receivers 130. The matching of the groups of receivers 130 with the corresponding pre-defined multicast IP addresses may be based on various criteria, which are out of the scope of the present disclosure.

The multicast IP address for transmitting the switch command may be pre-configured in the receiver 130. Alternatively, the multicast IP address for transmitting the switch command is notified to the receiver 130 by the controller 120. For example, the multicast IP address for transmitting the switch command is included in the SDP profile (transmitted from the controller 120 to the receiver 130 as illustrated in FIG. 8B) of the second video stream.

In an exemplary implementation, the multicast IP packet transporting the switch command is compliant with the SAP protocol. Furthermore, an SDP payload comprising the switch command and optional parameter(s) of the switch command is embedded in the multicast IP packet compliant with the SAP protocol.

The switch command comprises at least one parameter consisting of synchronization information defining when to perform the switch from the first video stream to the second video stream. For example, the synchronization information consists of a time at which the switch shall be performed. In another example, the synchronization information consists of a given frame at which the switch shall be performed. The given frame is identified by its frame number. Alternatively, the given frame is identified by another unique information associated to the given frame. The given frame is defined with respect to the first video stream. Thus, when the first video stream reaches the given frame, the receiver 130 switches to the second video stream. For instance, the receiver 130 displays (on a display associated to the receiver 130) the first video stream up to the given frame of the first video stream, and then starts displaying the second video stream. The given frame may also be defined with respect to the second video stream. Since the receiver 130 is also receiving the second video stream, it can monitor the second video stream to detect the occurrence of the given frame in the second video stream; and switch from the first to the second video stream upon the occurrence of the given video frame in the second video stream.

The synchronization information is not limited to a time or a video frame (number). Other types of data may be used for implementing the synchronization information.

Furthermore, alternatively or complementarity, performing the switch consists in applying one or more video processing functionality (different from performing a display) to the second video stream instead of the first video stream.

Since the receiver 130 may be receiving a plurality of media streams, the switch command also includes a unique identifier of the first video stream and a unique identifier of the second video stream. For example, the unique identifier of the video streams consists of their respective multicast IP addresses. However, any information included in the SDP profiles (transmitted from the controller 120 to the receiver 130 as illustrated in FIGS. 7B and 8B) of the video streams allowing to uniquely identify each video stream can be used. Furthermore, in a case where there is no ambiguity on which video streams the switch shall be applied to, there is no need to include a unique identifier of the video streams in the switch command.

FIG. 9B illustrates the receiver 130 only receiving the second video stream from the second video source 140 and the audio stream from the audio source 110 after the switch has occurred. The receiver 130 is no longer receiving the first video stream from the video source 100. For example, after the switch, the receiver 130 leaves the multicast group for receiving the first video stream.

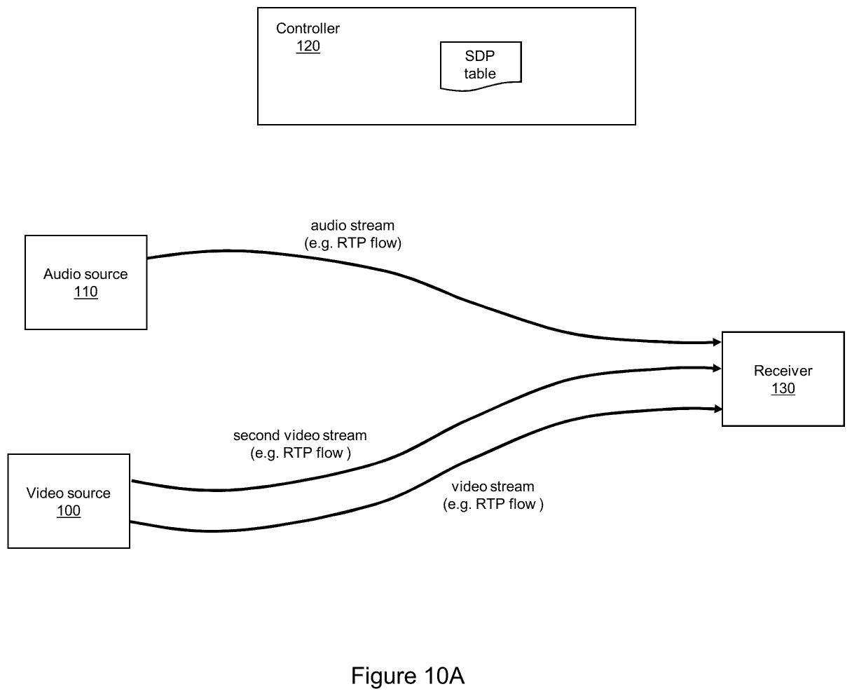

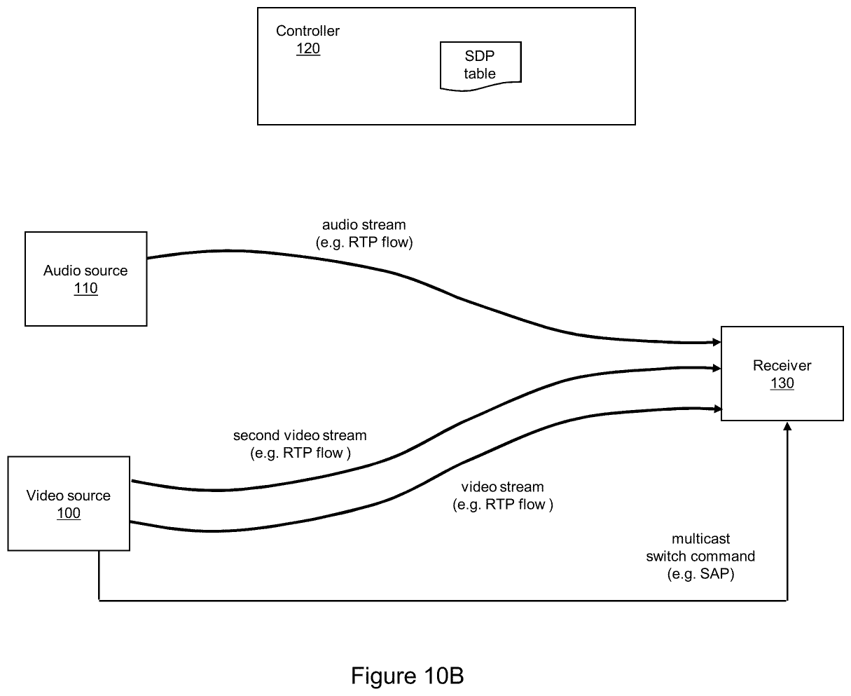

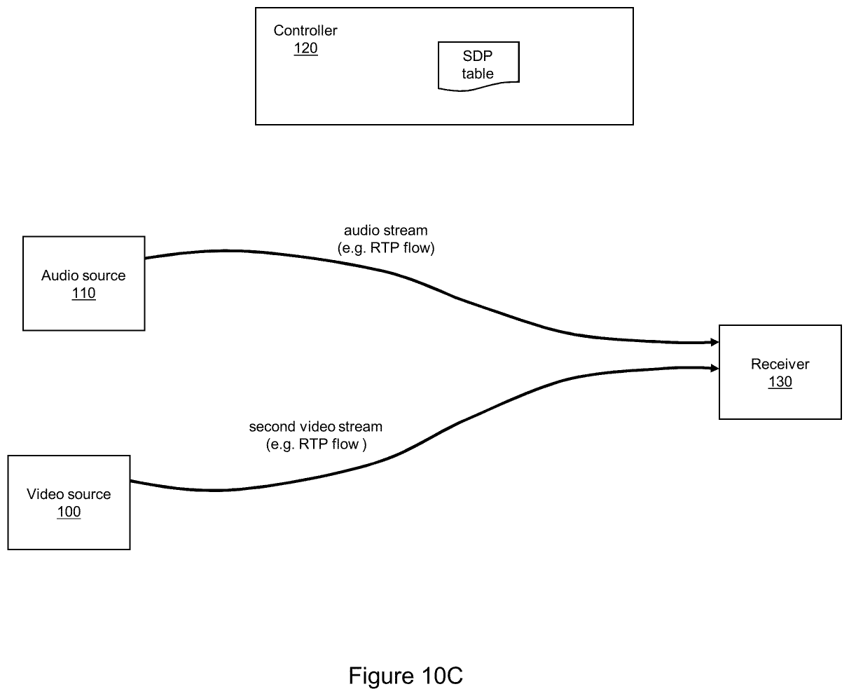

Reference is now made to FIGS. 10A, 10B and 10C, which illustrate the control of the transition from the first video stream to the second video stream in a configuration different from the one illustrated in FIGS. 9A and 9B.

FIG. 10A illustrates a configuration where the second video stream is also generated by the video source 100 (and not by a different video source 140 as illustrated in FIGS. 9A and 9B).

The steps for establishing the transmission of the second video stream from the video source 100 to the receiver 130 are similar to the previously described steps for establishing the transmission of the second video stream from the second video source 140 to the receiver 130, as illustrated in FIGS. 8A-C.

FIG. 10B illustrates the transmission by the video source 100 of the multicast switch command via a multicast IP packet to the receiver 130. The characteristics of the switch command are similar to the previously described switch command illustrated in FIG. 9A.

In this configuration, the switch command is not generated and sent by the controller 120. The two video streams originate from the video source 100 and the video source 100 has all the information necessary to determine when the switch from the first video stream to the second video stream shall be applied. This configuration illustrates a decentralized use case, where the video source 100 is capable of taking autonomous decisions. However, in a centralized use case (not represented in the Figures), the switch command would be generated and sent by the controller 120 although the first and second video streams both originate from the same video source 100.

FIG. 10C illustrates the receiver 130 only receiving the second video stream from the video source 100 and the audio stream from the audio source 110 after the switch has occurred. The receiver 130 is no longer receiving the first video stream from the video source 100. For example, after the switch, the receiver 130 leaves the multicast group for receiving the first video stream.

Although the previous example illustrates the switch between two media streams consisting of two video streams, the present disclosure is not limited to this example. For example, the switch may consist of a switch between two audio streams. More generally, the teachings of the present disclosure can be extended to the switch from one IP flow to another IP flow.

Furthermore, FIGS. 8B, 8C and 9A illustrate a use case where the receiver 130 starts receiving the second video stream after reception of the SDP profile corresponding to the second video stream, and before receiving the multicast switch command. The synchronization information of the multicast switch command defines when the second video stream shall be used (e.g. displayed, processed, etc.) in place of the first video stream. In another use case, the synchronization information of the multicast switch command defines when the receiver 130 shall start receiving the second video flow. For example, the moment at which the receiver 130 joins a multicast group associated to the second video stream and leaves a multicast group associated to the first video stream is based on the synchronization information of the multicast switch command. This second use case has not been illustrated in the Figures.

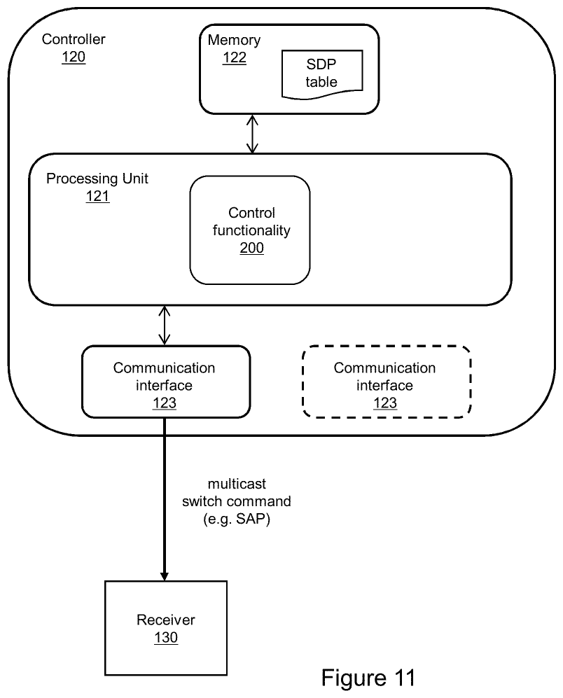

Referring now to FIG. 11, details of the controller 120 represented in FIGS. 7A to 10C are illustrated. Examples of controllers 120 include a switch, a router, a server, etc.

The controller 120 comprises a processing unit 121, memory 122, and at least one communication interface 123. The controller 120 may comprise additional components (not represented in FIG. 11 for simplification purposes). For example, the controller 120 may include a user interface and/or a display.

The processing unit 121 comprises one or more processors (not represented in FIG. 11) capable of executing instructions of a computer program. Each processor may further comprise one or several cores. In the case where the controller 120 represents a switch or a router, the processing unit 121 further includes one or more dedicated processing components (e.g. a network processor, an Application Specific Integrated Circuits (ASIC), etc.) for performing specialized networking functions (e.g. packet forwarding).

The processing unit 121 executes a control functionality 200 implemented by one or more computer programs. The control functionality 200 executes the previously described operations performed by the controller 120 in relation to FIGS. 7A to 10C.

The memory 122 stores instructions of computer program(s) executed by the processing unit 121, data generated by the execution of the computer program(s) by the processing unit 121, data received via the communication interface(s) 123, etc. A single memory 122 is represented in FIG. 11, but the controller 120 may comprise several types of memories, including volatile memory (such as Random Access Memory (RAM)) and non-volatile memory (such as a hard drive, Erasable Programmable Read-Only Memory (EPROM), Electrically-Erasable Programmable Read-Only Memory (EEPROM), etc.).

The memory 122 stores the previously described SDP table illustrated in Figures in FIGS. 7A to 10C.

Each communication interface 123 allows the controller 120 to exchange data with other devices. Examples of communication interfaces 123 include standard (electrical) Ethernet ports, fiber optic ports, ports adapted for receiving Small Form-factor Pluggable (SFP) units, etc. The communication interfaces 123 are generally of the wireline type; but may also include some wireless ones (e.g. a Wi-Fi interface). Each communication interface 123 comprises a combination of hardware and software executed by the hardware, for implementing the communication functionalities of the communication interface 123. Alternatively, the combination of hardware and software for implementing the communication functionalities of the communication interface 123 is at least partially included in the processing unit 121.

The one or more communication interface 123 is used for exchanging data (SDP profiles) with the video (100, 140) and audio (110) sources of FIGS. 7A to 10C. The one or more communication interface 123 is also used for exchanging data (SDP profiles and switch command) with the receiver 130 of FIGS. 7A to 10C. For simplification purposes, FIG. 11 only represents the transmission of the multicast switch command from the controller 120 to the receiver 130.

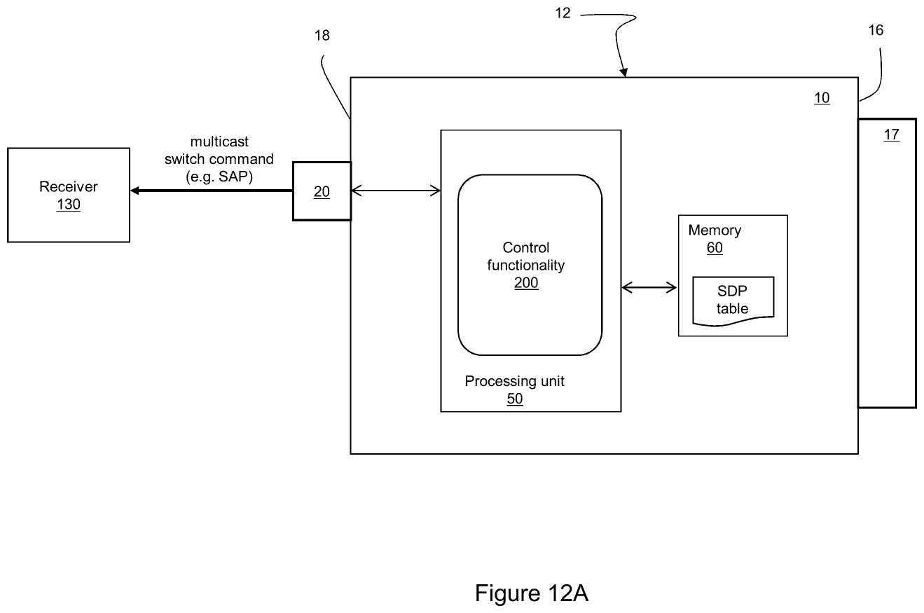

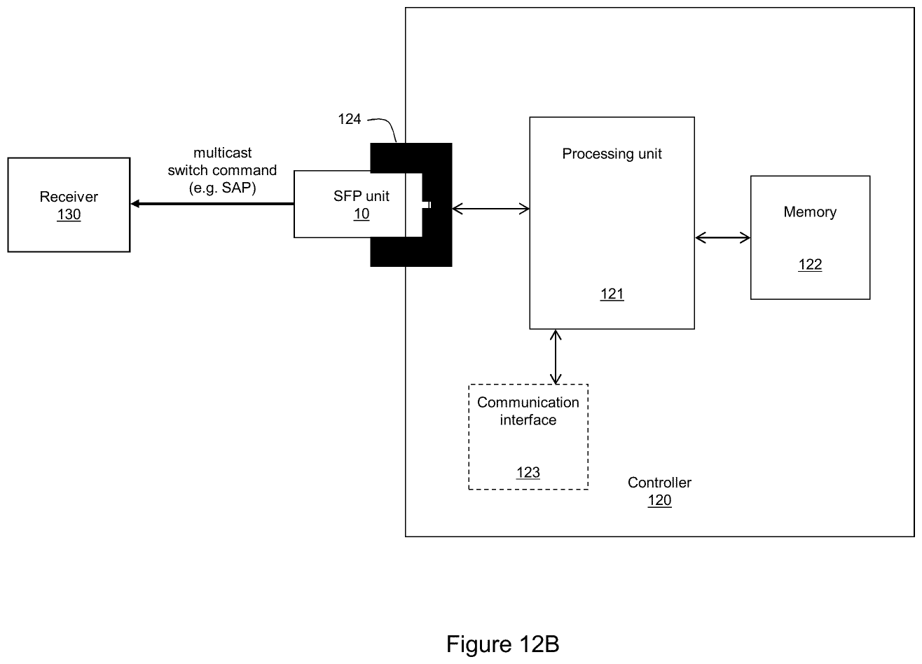

Referring now to FIGS. 12A and 12B, additional details of the SFP unit 10 represented in FIGS. 1 to 6 are illustrated.

The SFP unit 10 comprises a processing unit 50 in the housing 12 executing the control functionality 200. The control functionality 200 is implemented by a software executed by the processing unit 50. Alternatively, the control functionality 200 is implemented by dedicated hardware component(s) of the processing unit 50 (e.g. one or several Field-Programmable Gate Array (FPGA)).

The SFP unit 10 also comprises a memory 60 in the housing 12 for storing the SDP table.

As illustrated in FIG. 12B, the SFP unit 10 is inserted into a port 124 of the controller 120. Although not represented in FIG. 12B for simplification purposes, the controller 120 generally comprises a plurality of ports adapted for respectively receiving SFP units. In the rest of the description, a port adapted to receive an SFP unit will be referred to as an SFP port.

FIGS. 12A and 12B illustrate a configuration where the control functionality 200 and the SDP table are respectively executed and stored by the SFP unit 10, instead of the hosting unit (the controller 120) into which the SFP unit 10 is inserted.

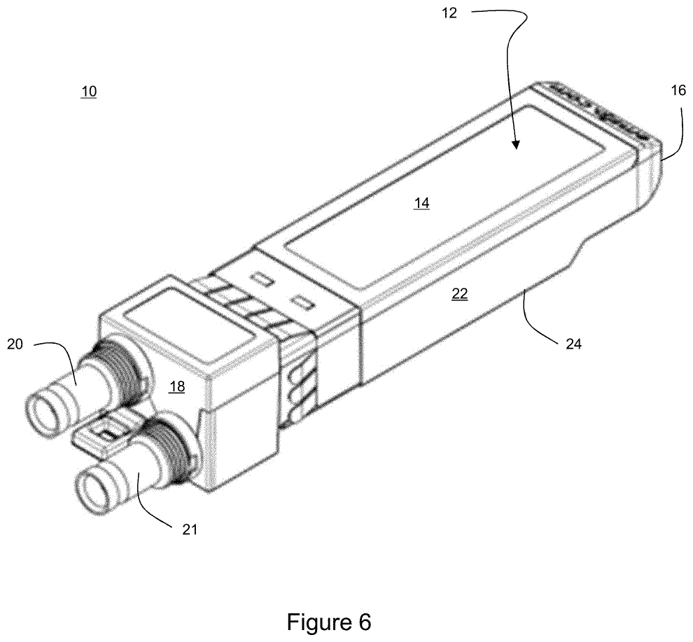

The front connector 20 of the SFP unit 10 is used for exchanging data (SDP profiles) with the video (100, 140) and audio (110) sources of FIGS. 7A to 10C. The front connector 20 is also used for exchanging data (SDP profiles and switch command) with the receiver 130 of FIGS. 7A to 10C. For simplification purposes, FIGS. 12A and 12B only represent the transmission of the multicast switch command from the SFP unit 10 to the receiver 130. Optionally, more than one front connector (e.g. front connectors 20 and 21 of FIG. 6) of the SFP unit 10 is used for exchanging data with the video sources (100, 140), the audio (110) source and the receiver 130 of FIGS. 7A to 10C. Furthermore, the rear connector 17 of the SFP unit 10 may also be used for exchanging some of these data. In this case, the exchanged data transit through the processing unit 121 of the controller 120 and the communication interface 123 of the controller 120.

The present disclosure is not limited to SFP units or standardized hot-pluggable transceiving units comprising a housing with standardized dimensions. The present disclosure also applies to any transceiving unit 10 adapted to being inserted into a corresponding port 124 of a hosting unit (the controller 120). The only constraint is that the transceiving unit 10 and the corresponding insertion port 124 of the hosting unit have compatible characteristics (e.g. in terms of shape, electrical interfaces, etc.).

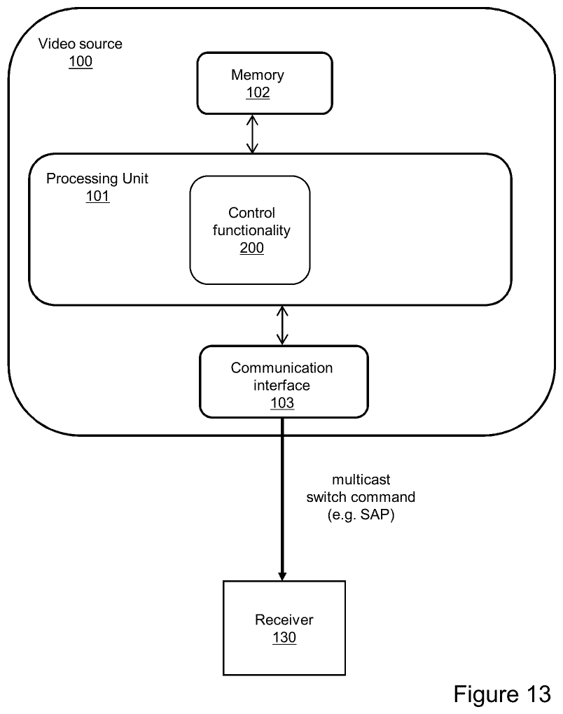

Referring now to FIG. 13, details of the video source 100 represented in FIGS. 7A to 10C are illustrated. Examples of video sources 100 include a server, a professional camera, etc. FIG. 13 corresponds to the use case represented in FIGS. 10A and 10B, where the video source 100 generates and transmits the first and second video streams.

The video source 100 comprises a processing unit 101, memory 102, and at least one communication interface 103. The video source 100 may comprise additional components (not represented in FIG. 13 for simplification purposes). For example, the video source 100 may include a user interface and/or a display.

The characteristics of the processing unit 101, memory 102 and communication interface 103 are similar to the previously described characteristics of the processing unit, memory and communication interface of the controller 120 of FIG. 11.

The processing unit 101 executes the control functionality 200. However, the functionalities of the control functionality 200 when executed by the processing unit 101 are limited to the generation and transmission of the multicast switch command to the receiver 130. The collection of the SDP profiles from the media sources (e.g. video source 100) and the transmission of the SDP profiles to the receiver 130 are performed by the control functionality 200 executed by one of the processing unit 121 of the controller 120 of FIG. 11 or the processing unit 50 of the SFP unit 10 of FIG. 12A.

The transmission of the multicast switch command to the receiver 130 can be triggered in different ways. Referring to FIGS. 11 and 13, the controller 120 and the video source 100 may include a user interface (not represented in the Figures for simplification purposes); and a user triggers the transmission of the multicast switch command to the receiver 130 via the user interface. Alternatively, the controller 120 and the video source 100 receive a control command from a remote computing device (not represented in the Figures for simplification purposes) via their respective communication interface 123 and 103; and the control command triggers the transmission of the multicast switch command to the receiver 130. Referring to FIG. 12A, the SFP unit 10 receives a control command from a remote computing device via its front connector 20 (or another connector of the SFP unit 10); and the control command triggers the transmission of the multicast switch command to the receiver 130.

Referring now to FIGS. 11, 12A, 12B, 13, 14A and 14B, a method 300 for transmitting a multicast command for synchronized media switch is illustrated. The steps of the method 300 are implemented by the controller 120 and the receiver 130, which have been described previously and represented in FIGS. 7A to 10C.

In a first configuration, the steps of the method 300 implemented by the controller 120 are executed by the processing unit 121 of the controller 120. In a second configuration, the steps of the method 300 implemented by the controller 120 are executed by the processing unit 50 of the SFP unit 10 inserted into the SFP port 124 of the controller 120. The steps of the method 300 implemented by the receiver 130 are executed by a processing unit (not represented in the Figures for simplification purposes) of the receiver 130.

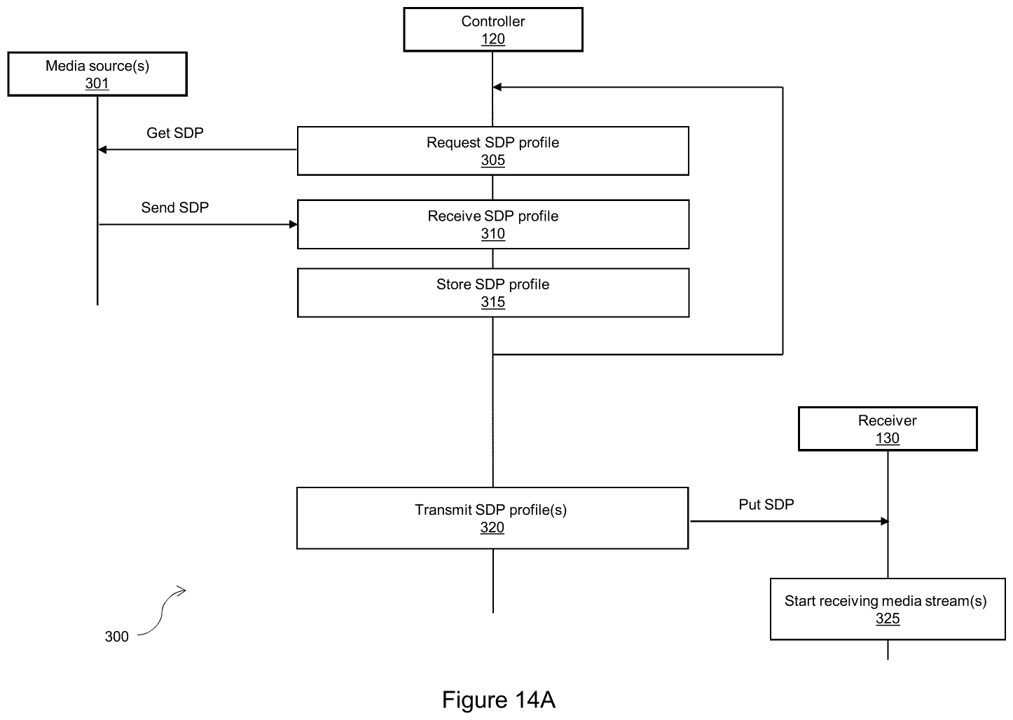

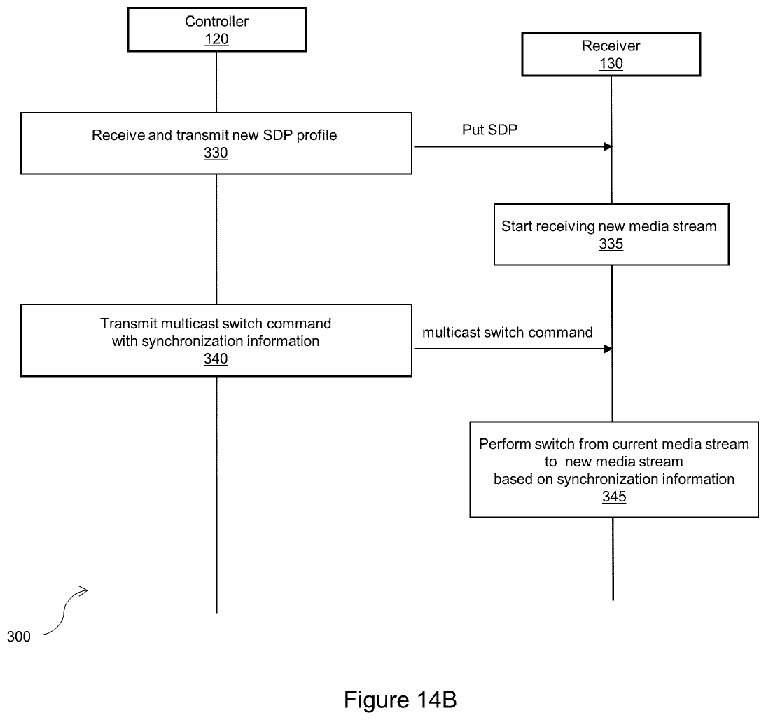

The media source 301 represented in FIG. 14A corresponds to any of the media sources 100 (video source), 110 (audio source) and 140 (second video source) illustrated in FIGS. 7A to 10C.

The method 300 comprises the step 305 of transmitting a request for an SDP profile of one of the media sources 301. Step 305 is executed by the controller 120 or the SFP unit 10 inserted into the SFP port 124 of the controller 120.

The method 300 comprises the step 310 of receiving the SDP profile (requested at step 305) from the media source 301. Step 310 is executed by the controller 120 or the SFP unit 10 inserted into the SFP port 124 of the controller 120.

The method 300 comprises the step 315 of storing the SDP profile (received at step 310) in a memory (e.g. memory 122 of the controller 120 or memory 60 of the SFP unit 10). Step 315 is executed by the controller 120 or the SFP unit 10 inserted into the SFP port 124 of the controller 120.

Steps 305, 310 and 315 may be repeated for a plurality of media sources 301. For example, steps 305-315 are performed for the video source 100 and the audio source 110 represented in FIG. 7A.

The method 300 comprises the step 320 of transmitting the SDP profile(s) (received at step 310) to the receiver 130. Step 320 is executed by the controller 120 or the SFP unit 10 inserted into the SFP port 124 of the controller 120. Step 320 is illustrated in FIG. 7B.

The method 300 comprises the step 325 of starting to receive the media stream(s) corresponding to the SDP profile(s) transmitted at step 320. Step 325 is executed by the receiver 130. As mentioned previously, the SDP profile(s) comprise information describing the media stream(s), allowing the receiver 130 to initiate the transmission of the media stream(s) from the media source(s) 301 to the receiver 130 based on the information of the SDP profile(s). Step 325 is illustrated in FIG. 7C, where the video source 100 and the audio source 110 respectively transmit a video stream and an audio stream to the receiver 130. The reception of the media stream(s) occurs during the following steps of the method 300, unless it is explicitly mentioned that the reception of one of the media stream(s) is interrupted.

The method 300 comprises the step 330 of receiving and transmitting a new SDP profile. The SDP profile is received from a media source 301 and transmitted to the receiver 130. Step 330 is executed by the controller 120 or the SFP unit 10 inserted into the SFP port 124 of the controller 120. Step 330 comprises the execution of steps 305, 310, 315 and 320; which have not been represented in detail in FIG. 14B for simplification purposes. Step 320 is illustrated in FIGS. 8A and 8B, where the SDP profile of the second video source 140 is retrieved by the controller 120 and transmitted to the receiver 130. The precise moment at which step 330 is executed may vary. For instance, step 330 is executed before step 325 instead of after step 325.

The method 300 comprises the step 335 of starting to receive the new media stream corresponding to the new SDP profile transmitted at step 330. Step 335 is executed by the receiver 130. As mentioned previously, the new SDP profile comprise information describing the new media stream, allowing the receiver 130 to initiate the transmission of the new media stream from the media source 301 to the receiver 130 based on the information of the new SDP profile. Step 335 is illustrated in FIG. 8C, where the second video source 140 transmits a second video stream to the receiver 130. The reception of the new media stream occurs during the following steps of the method 300, unless it is explicitly mentioned that the reception of the new media stream is interrupted.

The method 300 comprises the step 340 of transmitting a multicast switch command (e.g. an SAP switch command) with synchronization information to the receiver 130. Step 340 is executed by the controller 120 or the SFP unit 10 inserted into the SFP port 124 of the controller 120. Step 340 is illustrated in FIG. 9A.

The method 300 comprises the step 345 of performing a switch from a current media stream (which started being received at step 325) to the new media stream (which started being received at step 335) based on the synchronization information transmitted at step 340. Step 345 is executed by the receiver 130. Step 345 is illustrated in FIGS. 9A and 9B. Although not represented in FIG. 9B, the switch consists in displaying the second video stream instead of the first video stream on a display of the receiver 130. Alternatively or complementarity, the switch consists in applying one or more video processing functionality (different from performing a display) to the second video stream instead of the first video stream by the processing unit of the receiver 130. Furthermore, after the switch, the receiver 130 stops receiving the first video stream, as illustrated in FIG. 9B. As mentioned previously, the synchronization information consists of a time, a given frame, etc.

In an alternative implementation, step 340 of the method 300 is performed by a processing unit of a media source 301 (more specifically the media source 301 which generates and transmits the new media stream of step 335). This use case has been described previously and is illustrated in FIGS. 10A, 10B, 10C and 13. In particular, FIG. 13 represents the video source 100 implementing the control functionally 200 executed by the processing unit 101. The control functionality 200 performs step 340 of the method 300 (multicast switch command transmitted from the video source 100 to the receiver 130).

The data received and transmitted by the media sources 301, controller 120 and receiver 130 when executing the method 300 are exchanged via their respective communication interfaces (e.g. communication interface 123 of the controller 120, front connector 20 of the SFP unit 10 and communication interface 103 of the video source 100).

A dedicated computer program has instructions for implementing some of the steps of the method 300 when executed by the controller 120. The instructions are comprised in a non-transitory computer program product (e.g. the memory 122) of the controller 120. The instructions, when executed by the processing unit 121 of the controller 120, provide for performing steps 305, 310, 315, 320, 330 and 340 of the method 300. The instructions are deliverable to the controller 120 via an electronically-readable media such as a storage media (e.g. CD-ROM, USB key, etc.), or via communication links (e.g. via a communication network through the communication interface 123).

Similarly, a dedicated computer program has instructions for implementing some of the steps of the method 300 when executed by the SFP unit 10. The instructions are comprised in a non-transitory computer program product (e.g. the memory 60) of the SFP unit 10. The instructions, when executed by the processing unit 50 of the SFP unit 10, provide for performing steps 305, 310, 315, 320, 330 and 340 of the method 300. The instructions are deliverable to the SFP unit 10 via via communication links (e.g. via a communication network through the front connector 20).

Furthermore, a dedicated computer program has instructions for implementing step 340 of the method 300 when executed by the video source 100. The instructions are comprised in a non-transitory computer program product (e.g. the memory 102) of the video source 100. The instructions, when executed by the processing unit 101 of the video source 100, provide for performing step 340 of the method 300. The instructions are deliverable to the video source 100 via an electronically-readable media such as a storage media (e.g. CD-ROM, USB key, etc.), or via communication links (e.g. via a communication network through the communication interface 103).

The trigger of step 340 (e.g. by a user via a user interface or by the reception of a control command via a communication interface) has been described previously; and is not represented in FIG. 14B for simplification purposes.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A computing device comprising:
a communication interface; and
a processing unit for:
generating a multicast Internet Protocol (IP) packet comprising a command for switching from a first media stream to a second media stream, the command comprising synchronization information defining when to perform the switch; and
transmitting the multicast IP packet comprising the switch command via the communication interface to a remote computing device receiving the first and second media streams.

2. The computing device of claim 1, wherein the computing device is a transceiving unit comprising a housing adapted to being inserted into a chassis of a hosting unit, the processing unit is in the housing, and the communication interface is a connector of the transceiving unit.

3. The computing device of claim 2, wherein the transceiving unit is a standardized hot-pluggable transceiving unit and the housing has standardized dimensions.

4. The computing device of claim 1, wherein the multicast IP packet is compliant with the Session Announcement Protocol (SAP).

5. The computing device of claim 4, wherein the command is compliant with the Session Description Protocol (SDP) format.

6. The computing device of claim 1, wherein the first and second media streams consist of two video IP flows or two audio IP flows.

7. The computing device of claim 1, wherein the synchronization information defining when to perform the switch consists of a time at which the switch shall be performed.

8. The computing device of claim 1, wherein the first and second media streams consist of a first and a second video IP flows, and the synchronization information defining when to perform the switch consists of a given frame of one of the first and second video IP flows.

9. The computing device of claim 1, wherein the command further comprises a unique identifier for each one of the first and second media streams.

10. The computing device of claim 1, wherein the processing unit generates an SDP profile comprising the multicast IP address of the multicast IP packet comprising the switch command, and the processing unit transmits the SDP profile via the communication interface to the remote computing device receiving the first and second media streams.

11. A method for transmitting a multicast command for synchronized media switch, the method comprising:
generating by a processing unit of a computing device a multicast Internet Protocol (IP) packet comprising a command for switching from a first media stream to a second media stream, the command comprising synchronization information defining when to perform the switch; and
transmitting by the processing unit of the computing device the multicast IP packet comprising the switch command via a communication interface of the computing device to a remote computing device receiving the first and second media streams.

12. The method of claim 11, wherein the computing device is a transceiving unit comprising a housing adapted to being inserted into a chassis of a hosting unit, the processing unit is in the housing, and the communication interface is a connector of the transceiving unit.

13. The method of claim 12, wherein the transceiving unit is a standardized hot-pluggable transceiving unit and the housing has standardized dimensions.

14. The method of claim 11, wherein the multicast IP packet is compliant with the Session Announcement Protocol (SAP).

15. The method of claim 14, wherein the command is compliant with the Session Description Protocol (SDP) format.

16. The method of claim 11, wherein the first and second media streams consist of two video IP flows or two audio IP flows.

17. The method of claim 11, wherein the synchronization information defining when to perform the switch consists of a time at which the switch shall be performed.

18. The method of claim 11, wherein the first and second media streams consist of a first and a second video IP flows, and the synchronization information defining when to perform the switch consists of a given frame of one of the first and second video IP flows.

19. The method unit of claim 11, wherein the processing unit of the computing device generates an SDP profile comprising the multicast IP address of the multicast IP packet comprising the switch command; and the processing unit of the computing device transmits the SDP profile via the communication interface of the computing device to the remote computing device receiving the first and second media streams.

20. A non-transitory computer program product comprising instructions executable by a processing unit of a computing device, the execution of the instructions by the processing unit of the computing device providing for transmitting a multicast command for synchronized media switch by:
generating by the processing unit of the computing device a multicast Internet Protocol (IP) packet comprising a command for switching from a first media stream to a second media stream, the command comprising synchronization information defining when to perform the switch; and
transmitting by the processing unit of the computing device the multicast IP packet comprising the switch command via a communication interface of the computing device to a remote computing device receiving the first and second media streams.
